(19) United States
(12) Patent Application Publication
(10) Pub. No.: US 2019/0062531 A1
(43) Pub. Date: Feb. 28, 2019

(54) PNEUMATIC TIRE

(71) Applicants: Kraton Chemical, LLC, Jacksonville, FL (US); Sumitomo Rubber Industries, Ltd., Kobe-shi (JP)

(72) Inventors: Wolfgang Pille-Wolf, Wokuhl-Dabelow (DE); Jérémie Pichereau, Almere (NL); Mikako Takenaka, Kobe-shi (JP); Ryoji Kojima, Kobe-shi (JP); Suguru Izumo, Kobe-shi (JP)

(73) Assignees: Kraton Chemical, LLC, Jacksonville, FL (US); Sumitomo Rubber Industries, Ltd., Kobe-shi (JP)

(21) Appl. No.: 15/690,716

(22) Filed: Aug. 30, 2017

(51) Int. Cl. C08L 9/06; B60C 1/00

(52) U.S. Cl. CPC C08L 9/06; B60C 1/0016

(57) ABSTRACT

There is provided a pneumatic tire having improved wet grip performance and fuel efficiency in a good balance. The pneumatic tire is provided with a tread composed of a rubber composition comprising not less than 0.5 part by mass of silica and 5 to 50 parts by mass of a resin having a melt viscosity (150° C.) of 12000 to 15000 mPa·s based on 100 parts by mass of a rubber component. The rubber component comprises 40 to 100% by mass of a styrene-butadiene rubber and 0 to 60% by mass of a butadiene rubber. The resin is selected from the group consisting of a terpene phenol resin, a phenol resin and an alkylphenol resin.

### TECHNICAL FIELD

The present disclosure relates to a pneumatic tire having a tread composed of a specific rubber composition.

### BACKGROUND ART

Recently fuel consumption of a vehicle has been reduced by decreasing rolling resistance of a tire and inhibiting heat build-up of a tire. A demand for fuel efficiency of a vehicle is increasing. Among tire components, excellent low heat build-up property (fuel efficiency) is required in particular for a tread because it has a high occupation rate in the tire. Further, in the light of safety during running of a vehicle, wet grip performance is also required for a tread.

Generally in order to enhance fuel efficiency, it is effective to decrease a hysteresis loss (tan δ) of a rubber composition. Further, in order to enhance wet grip performance, a method of increasing a frictional force of a hysteresis loss friction, an adhesive friction and a digging friction is considered.

However, when a hysteresis loss is decreased to enhance fuel efficiency, there is a problem that a hysteresis loss friction becomes small and wet grip performance is deteriorated. That is, it is difficult to achieve both of fuel efficiency and wet grip performance only by a viscoelastic property (tan δ).

JP 2016-210937 describes a method of enhancing grip performance by combining an adhesion-imparting resin with a specific elastomer. However, there is no disclosure with respect to improvement of both wet grip performance and fuel efficiency in a good balance.

### SUMMARY OF THE INVENTION

The disclosure provides a pneumatic tire assuring wet grip performance and fuel efficiency improved in a good balance.

After an intensive study and as a result, it was found that by compounding a specific resin into a rubber composition for a tread, the above-mentioned problem can be solved, and further have repeated studies and have completed the disclosure.

In one aspect, the disclosure relates to: a pneumatic tire provided with a tread composed of a rubber composition comprising: not less than 0.5 part by mass of silica and 5 to 50 parts by mass of a resin having a melt viscosity (150° C.) of 12000 to 15000 mPa·s based on 100 parts by mass of a rubber component; wherein, the rubber component comprises 40 to 100% by mass of a styrene-butadiene rubber and 0 to 60% by mass of a butadiene rubber; and wherein, the resin is at least one selected from the group consisting of a terpene-phenol resin, a phenol resin and an alkyl phenol resin. In another aspect, the rubber composition further comprises 1 to 150 parts by mass of carbon black. In yet another aspect, the rubber composition further comprises 1 to 20 parts by mass of a silane coupling agent based on 100 parts by mass of silica.

Accordingly, a pneumatic tire assuring wet grip performance and fuel efficiency improved in a good balance can be provided.

While there is no intention of being constrained by any particular theory, it is believed by compounding a resin having a specified melt viscosity in a rubber composition, an adhesive layer comprising the resin is generated in the rubber composition, thereby increasing adhesion of the rubber composition and increasing cohesive friction, which leads to enhancement of wet grip performance. It is considered that the enhancement of wet grip performance by such a mechanism is independent of a hysteresis loss, and as a result, wet grip performance and fuel efficiency are improved in a good balance.

### DESCRIPTION OF EMBODIMENTS

In one embodiment, a pneumatic tire is provided with a tread composed of a rubber composition comprising not less than 0.5 part by mass of silica and 5 to 50 parts by mass of a resin having a melt viscosity (150° C.) of 12000 to 15000 mPa·s based on 100 parts by mass of a rubber component. The rubber component in one embodiment comprises 40 to 100% by mass of a styrene-butadiene rubber and 0 to 60% by mass of a butadiene rubber.

Rubber Component.

In one embodiment, the rubber component comprises any of unsaturated diene elastomer selected from natural rubber, synthetic polyisoprenes, butadiene copolymers, isoprene copolymers and the mixtures of such elastomer, a non-diene rubber such as butyl rubber, halogenated butyl rubber, and EPDM (Ethylene Propylene Diene Monomer rubber), and mixtures thereof. The rubber component may be coupled, star-branched, branched, and/or functionalized with a coupling and/or star-branching or functionalization agent. The branched rubber can be any of branched (“star-branched”) butyl rubber, halogenated star-branched butyl rubber, poly(isobutylene-co-p-methylstyrene), brominated butyl rubber, chlorinated butyl rubber, star-branched polyisobutylene rubber, and mixtures thereof.

Examples of coupling and/or star-branching or functionalizations include coupling with carbon black, e.g., with functional groups comprising a C—Sn bond or with aminated functional groups; coupling with a reinforcing inorganic filler, such as silica, e.g., with silanol functional groups or polysiloxane functional groups having a silanol end; alkoxysilane group, or polyether group. In one embodiment, the rubber component is a highly unsaturated rubber, end-chain functionalized with a silanol group. In another embodiment, the rubber component is a functionalized diene rubber bearing at least one SiOR function, R being a hydrogen or a hydrocarbon radical. In yet another embodiment, the rubber component consists of SBR, or of SBR and BR for improved wet grip performance. In yet another embodiment, the rubber is epoxide-functionalized (or epoxidized), bearing epoxide functional groups. The epoxidized elastomer can be selected from the group consisting of epoxidized diene elastomers, epoxidized olefinic elastomers and mixtures thereof.

In one embodiment, the rubber component is at least one selected from the group consisting of natural rubber (NR), styrene-butadiene rubber (SBR), butadiene rubber (BR), synthetic polyisoprene rubber, epoxylated natural rubber, nitrile-hydrogenated butadiene rubber HNBR, hydrogenated SBR, ethylene propylene diene monomer rubber, ethylene propylene rubber, maleic acid-modified ethylene propylene rubber, butyl rubber, isobutylene-aromatic vinyl or diene monomer copolymers, brominated-NR, chlorinated-NR, brominated isobutylene p-methylstyrene copolymer, chloroprene rubber, epichlorohydrin homopolymers rubber, epichlorohydrin-ethylene oxide or allyl glycidyl ether copolymer rubbers, epichlorohydrin-ethylene oxide-allyl glycidyl ether terpolymer rubbers, chlorosulfonated polyethylene, chlorinated polyethylene, maleic acid-modified chlorinated polyethylene, methylvinyl silicone rubber, dimethyl silicone rubber, methylphenylvinyl silicone rubber, polysulfide rubber, vinylidene fluoride rubbers, tetrafluoroethylene-propylene rubbers, fluorinated silicone rubbers, fluorinated phosphagen rubbers, styrene elastomers, thermoplastic olefin elastomers, polyester elastomers, urethane elastomers, and polyamide elastomers. Examplary natural rubber includes a latex collected by tapping Hevea brasiliensis, and a so-called “deproteinized natural rubber latex” obtained by removing proteins from a natural rubber latex. The SBR is not limited particularly, and usual ones in the rubber industry such as an emulsion-polymerized styrene-butadiene rubber (un-modified E-SBR), a solution-polymerized styrene-butadiene rubber (un-modified S-SBR) and modified SBRs obtained by modifying terminals thereof (modified E-SBR and modified S-SBR) can be used. In one embodiment, the rubber component comprises rubber components other than the SBR and the BR such as a natural rubber (NR), an isoprene rubber (IR), an epoxidized natural rubber (ENR), a butyl rubber, an acrylonitrile butadiene rubber (NBR), an ethylene propylene diene rubber (EPDM), a chloroprene rubber (CR) a styrene-isoprene-butadiene rubber (SIBR), used alone or in combinations according to necessity.

The BR is not limited particularly, and usual ones in the rubber industry such as a high-cis BR having a cis content of 90% or more, further preferably 95% by mass or more, a modified BR having a modified terminal and/or a modified main chain and a modified BR coupled with tin, a silicon compound or the like (a condensate, one having a branched structure or the like) can be used. The cis content can be calculated by, for example, an analysis of infrared absorption spectrum.

Specific examples of the BR include BRs having a high cis content (high-cis BR) such as BR1220 available from ZEON CORPORATION, CB24 available from LANXESS and BR150B available from Ube Industries, Ltd., BR having 1,2-syndiotactic polybutadiene crystal (SPB) such as VCR412 and VCR617 available from Ube Industries, Ltd., BR synthesized using a rare earth element catalyst (rare earth BR) and the like.

When the rubber component comprises BR, the content thereof in the rubber component is preferably not less than 5% by mass, more preferably not less than 10% by mass, further preferably not less than 15% by mass, further preferably not less than 20% by mass, further preferably not less than 25% by mass from the viewpoint of abrasion resistance. Further, the content of the BR is not more than 60% by mass, preferably not more than 50% by mass, more preferably not more than 40% by mass, further preferably not more than 35% by mass. When the content of the BR exceeds 60% by mass, grip performance tends to be inferior.

In one embodiment, a content of the SBR in the rubber component is not less than 40% by mass, preferably not less than 50% by mass, more preferably not less than 60% by mass, further preferably not less than 65% by mass. When the content of the SBR is less than 40% by mass, there is a tendency that wet grip performance and abrasion resistance cannot be obtained. Further, the content of the SBR can be 100% by mass, but is preferably not more than 95% by mass, more preferably not more than 90% by mass, further preferably not more than 85% by mass, further preferably not more than 80% by mass, further preferably not more than 75% by mass, from the viewpoint of fuel efficiency.

Filler.

A filler usually used in the rubber industry can be used suitably, and examples thereof include silica, carbon black, calcium carbonate, aluminum hydroxide, magnesium oxide, magnesium hydroxide, clay, talc, alumina, titanium oxide and the like, and the filler at least comprises silica. Further, carbon black is preferable as a filler except silica. The filler is preferably one comprising silica and carbon black.

Silica.

The silica is not limited particularly, and examples thereof include silica prepared by a dry method (anhydrous silica), silica prepared by a wet method (hydrous silica) and the like. For the reason that the number of silanol groups is large, silica prepared by a wet method is preferable.

A nitrogen adsorption specific surface area (N₂SA) of the silica is preferably not less than 80 m²/g, more preferably not less than 100 m²/g, further preferably not less than 150 m²/g, from the viewpoint of durability and elongation at break. Further, from the viewpoint of fuel efficiency and processability, the N₂SA of the silica is preferably not more than 250 m²/g, more preferably not more than 220 m²/g, further preferably not more than 200 m²/g. Herein, the N₂SA of the silica is a value measured in accordance with ASTM D3037-93.

An average primary particle size of the silica is preferably not more than 25 nm, more preferably not more than 22 nm, further preferably not more than 17 nm. A lower limit of the average primary particle size is not limited particularly, and is preferably not less than 3 nm, more preferably not less than 5 nm, further preferably not less than 7 nm. When the average primary particle size of the silica is within the above-mentioned range, dispersion of the silica can be improved more, and reinforceability, breaking characteristic and abrasion resistance can be further improved. It is noted that the average primary particle size of the silica can be determined by observing with a transmission type or scanning type electron microscope, measuring sizes of 400 or more primary particles observed within a visual field, and calculating an average thereof.

A content of the silica is not less than 0.5 part by mass, preferably not less than 30 parts by mass, more preferably not less than 50 parts by mass, further preferably not less than 60 parts by mass based on 100 parts by mass of the rubber component. When the content of the silica is less than 0.5 part by mass, there is a tendency that durability and elongation at break are lowered. Further, the content of the silica is preferably not more than 200 parts by mass, more preferably not more than 150 parts by mass, further preferably not more than 120 parts by mass, further preferably not more than 100 parts by mass from the viewpoint of dispersibility at the time of kneading and processability.

The silica can be used alone, or can be used in combination of two or more thereof.

Carbon Black.

The carbon black is not limited particularly, and examples thereof include those of SAF, ISAF, HAF, FF, FEF and GPF grades.

A nitrogen adsorption specific surface area (N₂SA) of the carbon black is preferably not less than 80 m²/g, more preferably not less than 100 m²/g, from the viewpoint of reinforceability and abrasion resistance. Further, from the viewpoint of dispersibility and fuel efficiency, the N₂SA of the carbon black is preferably not more than 280 m²/g, more preferably not more than 250 m²/g, further preferably not more than 200 m²/g, further preferably not more than 150 m²/g. It is noted that the nitrogen adsorption specific surface area of the carbon black is measured in accordance with JIS K6217 method A.

When the rubber composition comprises carbon black, the content thereof is preferably not less than 1 part by mass, more preferably not less than 3 parts by mass based on 100 parts by mass of the rubber component from the viewpoint of reinforceability. Further the content of the carbon black is preferably not more than 150 parts by mass, more preferably not more than 100 parts by mass, further preferably not more than 50 parts by mass, further preferably not more than 30 parts by mass, further preferably not more than 20 parts by mass from the viewpoint of processability, fuel efficiency and abrasion resistance.

The carbon blacks can be used alone, or can be used in combination of two or more thereof.

Coupling Agent.

The term “coupling” agent here refers to any agent capable of facilitating stable chemical and/or physical interaction between two otherwise non-interacting species, e.g., between a filler and an elastomer. The coupling agents may be pre-mixed, or pre-reacted, with the silica particles or added to the rubber mix during the rubber/silica processing, or mixing, stage. If the coupling agent and silica are added separately to the rubber mix during the rubber/silica mixing, or processing stage, the coupling agent then combines in situ with the silica. The coupling agent may be a sulfur-based coupling agent, an organic peroxide-based coupling agent, an inorganic coupling agent, a polyamine coupling agent, a resin coupling agent, a sulfur compound-based coupling agent, oxime-nitrosamine-based coupling agent, and sulfur. In one embodiment, the rubber composition comprises a silane coupling agent. Any of silane coupling agents which have been used together with silica can be used as the silane coupling agent. Examples thereof include sulfide silane coupling agents such as bis(3-triethoxysilylpropyl)tetrasulfide, bis(2-triethoxysilylethyl)tetrasulfide, bis(3-triethoxysilylpropyl)trisulfide, bis(2-triethoxysilylethyl)trisulfide, bis(3-triethoxysilylpropyl)disulfide and bis(2-triethoxysilylethyl)disulfide; mercapto silane coupling agents such as 3-mercaptopropyltrimethoxysilane, 3-mercaptopropyltriethoxysilane, 2-mercaptoethyltrimethoxysilane, 2-mercaptoethyltriethoxysilane and 3-octanoylthio-1-propyltriethoxysilane; vinyl silane coupling agents such as vinyltriethoxysilane and vinyltrimethoxysilane; amino silane coupling agents such as 3-aminopropyltriethoxysilane, 3-aminopropyltrimethoxysilane, 3-(2-aminoethyl) aminopropyltriethoxysilane and 3-(2-aminoethyl)aminopropyltrimethoxysilane; glycidoxy silane coupling agents such as γ-glycidoxypropyltriethoxysilane, γ-glycidoxypropyltrimethoxysilane, γ-glycidoxypropylmethyldiethoxysilane and γ-glycidoxypropylmethyl dimethoxysilane; nitro silane coupling agents such as 3-nitropropyltrimethoxysilane and 3-nitropropyltriethoxysilane; and chloro silane coupling agents such as 3-chloropropyltrimethoxysilane, 3-chloropropyltriethoxysilane, 2-chloroethyltrimethoxysilane and 2-chloroethyltriethoxysilane, and the like. Examples of trade names thereof inlcude Si69, Si75, Si363 and Si266 (available from Degussa) and NXT, NXT-LV, NXTULV and NXT-Z (available from Momentive).

When the rubber composition comprises the silane coupling agent, the content thereof is preferably not less than 1.0 part by mass, more preferably not less than 5.0 parts by mass, further preferably not less than 7.0 parts by mass, based on 100 parts by mass of the silica. When the content of the silane coupling agent is not less than 1.0 part by mass, there is a tendency that the silane coupling agent is reacted with the filler sufficiently and a good effect of the silane coupling agent for improving processability can be exhibited. Further, the content of the silane coupling agent is preferably not more than 20 parts by mass, more preferably not more than 15 parts by mass. When the content of the silane coupling agent is not more than 20 parts by mass, it tends to be advantageous from the viewpoint of cost performance.

These silane coupling agents may be used alone or may be used in combination of two or more thereof.

Resin.

The resin is a resin having a melt viscosity at 150° C. (also referred to as a melt viscosity (150° C.)) of 12000 to 15000 mPa·s.

Melt Viscosity.

The melt viscosity (150° C.) is a viscosity measured under the conditions of the number of revolutions of 3 rpm and a temperature of 150° C. with a Brookfield RTV viscometer (available from BROOKFIELD ENGINEERING LABS. INC.). When the melt viscosity (150° C.) is less than 12000 mPa·s, there is a tendency that enough wet grip performance cannot be obtained. On the other hand, when the melt viscosity (150° C.) exceeds 15000 mPa·s, there is a tendency that enough dispersion of the resin in the rubber composition is hardly made. The melt viscosity (150° C.) is preferably not less than 12500 mPa·s, more preferably not less than 12700 mPa·s, further preferably not less than 12800 mPa·s. On the other hand, the melt viscosity (150° C.) is preferably not more than 14500 mPa·s, more preferably not more than 14000 mPa·s, further preferably not more than 13500 mPa·s, further preferably not more than 13300 mPa·s, further preferably not more than 13200 mPa·s. The melt viscosity (150° C.) is most preferably about 13000 mPa·s. Here, “about” means that the difference of about ±100 mPa·s is allowable.

Softening Point.

A softening point of the resin is preferably not lower than 40° C., more preferably not lower than 60° C., further preferably not lower than 80° C., further preferably not lower than 100° C., further preferably not lower than 110° C., further preferably not lower than 120° C., from the viewpoint of hysteresis loss friction, steering stability and storage stability (prevention of blocking). On the other hand, the softening point of the resin is preferably not higher than 200° C., more preferably not higher than 150° C., further preferably not higher than 140° C., further preferably not higher than 130° C., from the viewpoint of dispersibility of the resin during kneading. The softening point of the resin is determined by the following method. Namely, while heating 1 g of the resin as a sample at a temperature elevating rate of 6° C. per minute with a flowtester (CFT-500D available from Shimadzu Corporation or the like), a load of 1.96 MPa is applied to the sample with a plunger, the sample is extruded through a nozzle having a diameter of 1 mm and a length of 1 mm, and a descending distance of the plunger of the flowtester is plotted to a temperature. The softening point of the resin is a temperature when a half of the sample was flowed out.

The resin is one having a high polarity among resins commonly used in the tire industry. Examples thereof include a terpene phenol resin, a phenol resin, an alkylphenol resin, and the like. It can be considered that since these resins include a phenol moiety therein, a polarity thereof is high and a frictional force thereof to a road surface becomes high.

The terpene phenol resin is a resin obtained by copolymerizing a starting monomer comprising a terpene compound and a phenol compound and a further hydrogenated resin of the obtained copolymerized resin. Here, the terpene compound, a polymer of isoprene (C₅H₈), is a compound having terpene, which is classified into mono-terpene (C₁₀H₁₆), sesqui-terpene (C₁₅H₂₄), di-terpene (C₂₀H₃₂) or the like, as a basic skeleton. More specifically, examples thereof include α-pinene, β-pinene, dipentene, limonene, myrcene, allo-ocimene, ocimene, α-phellandrene, α-terpinene, γ-terpinene, terpinolene, 1,8-cineol, 1,4-cineol, α-terpineol, β-terpineol, γ-terpineol, camphene, tricyclene, sabinene, paramentadienes, carenes and the like. Examples of the phenol compound include phenol, bisphenol A, cresol, xylenol and the like.

In one embodiment, the resin is a terpene phenol resin prepared in a process in which a mixture of dehydrated phenol solution and a boron trifluoride complex is heated to a temperature of about 50° C. to about 90° C. The boron trifluoride complex is selected from ether complexes of boron trifluoride and organic acid complexes of boron trifluoride. In the next step, a terpene, e.g., α-pinene, is added at a molar ratio of terpene to phenol in the range from about 1:1 to about 4:1 over a period of time from 0.5 to 10 hours, with the reaction mixture maintained in the range from about 50° C. to about 90° C. to produce the terpene phenol resin. The molar ratio of boron trifluoride to terpene and phenol is in the range of about 0.005:1 to about 0.5:1. In one embodiment, the molar ratio of terpene to phenol is in the range from about 2:1 to about 3.5:1. Boron trifluoride can be removed with the addition of a sodium carbonate solution. The top layer containing the resin can be isolated by distillation to remove solvent and terpene dimers. The terpene phenol resin produced has a softening point in the range of at least about 80° C. in one embodiment; about 110-135° C. in a second embodiment; about 120-130° C. in a third embodiment; and at least about 115° C. in a fourth embodiment. In one embodiment, the resin is blended with oil or other resin(s) to suppress the high softening point for a softening point of less than about 140° C.

Examples of the alkylphenol resin include alkylphenol-aldehyde condensation resins obtained by reacting alkylphenol with aldehyde such as formaldehyde, acetaldehyde or furfural using an acid or an alkali catalyst; alkylphenol-alkyne condensation resins obtained by reacting alkylphenol with alkyne such as acetylene; modified alkylphenol resins obtained by modifying the above resins with a compound such as cashew nut oil, tall oil, linseed oil, various animal and vegetable oils, unsaturated fatty acid, rosin, alkylbenzene resin, aniline, melamine or the like. Among these, alkylphenol-alkyne condensation resins are preferable, and an alkylphenol-acetylene condensation resin is particularly preferable. Examples of alkylphenol constituting the alkylphenol resin include cresol, xylenol, t-butylphenol, octylphenol, nonylphenol and the like. Among these, phenols having a branched alkyl group such as t-butylphenol are preferable, and t-butylphenol is particularly preferable.

Examples of monomers constituting the above resins include monomer components other than those mentioned above. Examples of such monomer components include (meth)acrylic acid derivatives such as (meth)acrylic acids, (meth)acrylic acid esters (alkyl ester, aryl ester, aralkyl ester and the like), (meth)acrylamides and (meth)acrylamide derivative; aromatic vinyl derivatives such as styrene, 4-tert-butylstyrene, indene, methylindene, α-methylstyrene, vinyltoluene, vinylnaphthalene, divinylbenzene, trivinylbenzene and divinylnaphthalene, and in general C9 petroleum fraction. Here, (meth)acrylic acid is a general name of acrylic acids and methacrylic acids.

The content of the resin is not less than 5 parts by mass based on 100 parts by mass of the rubber component. When the resin content is less than 5 parts by mass, there is a tendency that an amount of resin contained in the adhesion layer is small and sufficient adhesion of the rubber composition cannot be obtained. Further, the resin content is not more than 50 parts by mass. When the resin content is more than 50 parts by mass, there is a tendency that blooming cannot be inhibited sufficiently and abrasion resistance is inferior. The content of the resin is preferably not less than 10 parts by mass, more preferably not less than 15 parts by mass. On the other hand, the resin content is preferably not more than 40 parts by mass, more preferably not more than 30 parts by mass, further preferably not more than 25 parts by mass.

The resins can be used alone and can be used in combination of two or more thereof.

Oil.

The rubber composition may comprise oil. By compounding oil, processability can be improved and a strength of the rubber can be increased. Examples of oil include process oil, vegetable oil, animal oil and the like.

Examples of the process oil include paraffin process oil, olefin process oil, aromatic process oil, and the like. Further there are exemplified process oils having a low content of a polycyclic aromatic compound (PCA) in consideration of environment. Examples of process oils having a low PCA content include treated distillate aromatic extract (TDAE) obtained by re-extracting aromatic process oil, alternative aromatic oil which is a mixed oil of asphalt and naphthene oil, mild extraction solvates (MES), heavy naphthene oil, and the like. Examples of commercially available oil include Process X-260 (aromatic oil) available from Japan Energy Corporation and the like.

Examples of the vegetable oils include castor oil, cotton seed oil, linseed oil, rapeseed oil, soybean oil, palm oil, coconut oil, peanut oil, rosin, pine oil, pine tar, tall oil, corn oil, rice oil, sesame oil, olive oil, sunflower oil, palm kernel oil, camellia oil, jojoba oil, macadamia nut oil, safflower oil, tung oil, and the like.

Examples of animal oils include oleyl alcohol, fish oil, beef tallow and the like.

Among these oils, process oils are preferable for the reason that they are advantageous from the view point of processability, and from the view point of environmental aspect, use of process oils having a low PCA content is preferable.

In the case of an oil-containing rubber composition, the content of oil is preferably not less than 1 part by mass, more preferably not less than 2 parts by mass, further preferably not less than 5 parts by mass based on 100 parts by mass of the rubber component from the view point of processability. Further, the content of oil is preferably not more than 60 parts by mass, more preferably not more than 40 parts by mass, further preferably not more than 30 parts by mass, further preferably not more than 25 parts by mass, from the view point of abrasion resistance and processability.

Oils can be used alone, and can be used in combination of two or more thereof.

In the case of the rubber composition comprising both of the above resin and the oil, the total amount thereof is preferably from 6 parts by mass to 100 parts by mass. The total amount is more preferably not less than 10 parts by mass, further preferably not less than 15 parts by mass, further preferably not less than 20 parts by mass. On the other hand, the total amount is preferably not more than 75 parts by mass, more preferably not more than 65 parts by mass, further preferably not more than 60 parts by mass, further preferably not more than 55 parts by mass, further preferably not more than 50 parts by mass.

Other Compounding Agents.

In addition to the above-mentioned components, to the rubber composition of the disclosure can be properly added other compounding agents generally used in the tire industry, for example, a zinc oxide, a stearic acid, various anti-aging agents, wax, a vulcanizing agent, a vulcanization accelerator and the like.

Rubber Composition.

The rubber composition of the disclosure can be prepared by a usual method. The rubber composition can be prepared, for example, by a method of kneading the above-mentioned components except the vulcanizing agent and the vulcanization accelerator with a known kneading apparatus usually used in the rubber industry such as a Banbury mixer, a kneader or an open roll and then adding the vulcanizing agent and the vulcanization accelerator to the kneaded product and carrying out further kneading and vulcanization.

Tire.

The tire of the disclosure can be produced by a usual method using a tread produced using the rubber composition according to the disclosure. That is, the rubber composition according to the disclosure is extruded into the shape of a tread of a tire at an un-vulcanized stage, and laminated with other components of the tire in a tire building machine to form an unvulcanized tire. This unvulcanized tire is heated and pressurized in a vulcanizer and the tire can be produced. By putting air into the thus obtained tire, a pneumatic tire can be produced.

### Example

The disclosure will be described based on Examples, but the disclosure is not limited thereto only.

A variety of chemicals used in Examples and Comparative Examples will be collectively explained below:

Styrene-butadiene rubber (SBR): NS616 (un-modified S-SBR) manufactured by ZEON CORPORATION

Butadiene rubber (BR): CB24 (high-cis BR synthesized using an Nd-based catalyst, cis-content: 96% by mass) manufactured by LANXESS

Carbon black: SEAST N220 (N2SA: 114 m2/g) manufactured by Mitsubishi Chemical Corporation

Silica: Ultrasil VN3 (average primary particle size: 15 nm, N2SA: 175 m2/g) manufactured by Evonik Degussa

Silane coupling agent (coupling agent): Si75 (bis(3-triethoxysilylpropyl)disulfide) manufactured by Evonik Degussa

Oil: Process X-260 (aromatic oil) manufactured by Japan Energy Corporation

Resin 1: A terpene phenol resin with a softening point 80° C., and melt viscosity at 150° C.: 650 mPa·s, manufactured by Yasuhara Chemical Co., Ltd.

Resin 2: A terpene phenol resin with a softening point 145° C., and a melt viscosity at 150° C.: Nil (cannot be measured—out of scale), manufactured by Yasuhara Chemical Co., Ltd.

Resin 3: A terpene phenol resin with a softening point 125° C., a melt viscosity at 150° C.: 13000 mPa·s, a glass transition temperature of about 74° C., manufactured by Arizona Chemical Company

Stearic acid: Stearic acid “Tsubaki” manufactured by NOF Corporation

Anti-aging agent: Antigene 6C (N-(1,3-dimethylbutyl)-N′-phenyl-p-phenylenediamine) manufactured by Sumitomo Chemical Company, Limited

Zinc oxide: ZINC FLOWER No. 1 manufactured by Mitsui Mining & Smelting Co., Ltd.

Sulfur: Powdered sulfur manufactured by Karuizawa Iou Kabushiki Kaisha

Vulcanization accelerator: Nocceler NS (N-tert-butyl-2-benzothiazolylsulfeneamide) manufactured by OUCHI SHINKO CHEMICAL INDUSTRIAL CO., LTD.

According to compounding formulations shown in Table 1, chemicals other than sulfur and a vulcanization accelerator were kneaded with a 1.7 L enclosed Banbury mixer at the temperature at discharge of 150° C. for 5 minutes to obtain a kneaded product. Then, to the kneaded product were added sulfur and the vulcanization accelerator, and the mixture was kneaded using an open roll for 5 minutes until the temperature reached 80° C. to obtain an unvulcanized rubber composition. The obtained unvulcanized rubber composition was formed into the shape of a tread, laminated with other components of the tire to obtain an unvulcanized tire, and the unvulcanized tire was subjected to press-vulcanization at 170° C. for ten minutes to obtain tires for test (tire size: 195/65R15, tires for passenger vehicle). With respect to the obtained tires for test, the following tests were conducted. The results are shown in Table 1.

Wet Grip Performance Test.

Wet grip performance was evaluated based on braking performance obtained in an evaluation test using an antilock braking system (ABS). That is, the above-mentioned tires for test were mounted on a 1800 cc class vehicle equipped with ABS, and the vehicle was run on an asphalt road (wet road surface, skid number: about 50), and the vehicle was braked at a speed of 100 km/h and distance until the vehicle was stopped was determined. The wet grip performance of each compounding formulation is shown by an index in accordance with the following formula, assuming the index of the wet grip performance of the reference Comparative Example as 100. The larger the index is, the better the braking performance is and the more excellent the wet grip performance is.

(Index of wet grip performance)=(Stopping distance of reference Comparative Example)/(Stopping distance of each compounding formulation)×100

Fuel Efficiency Test.

Rolling resistance of tires for test when each tire was run under conditions of a rim (15×6 JJ), an inner pressure (230 kPa), a load (3.43 kN) and a speed (80 km/h) was measured with a rolling resistance testing machine and the result is shown by an index, assuming the result of the reference Comparative Example as 100. The larger the index is, the more excellent the fuel efficiency is and a target value for performance is not less than 90.

(Index of fuel efficiency)=(Rolling resistance of reference Comparative Example)/(Rolling resistance of each compounding formulation)×100

TABLE 1

| | Comparative Examples | | | Examples |
|---|---|---|---|---|
| | 1 | 2 | 3 | 2 |
| Compounded amount (part by mass) | | | | |
| SBR | 70 | 70 | 70 | 70 |
| BR | 30 | 30 | 30 | 30 |
| Carbon black | 10 | 10 | 10 | 10 |
| Silica | 80 | 80 | 80 | 80 |
| Coupling agent | 8 | 8 | 8 | 8 |
| Oil | 25 | 5 | 5 | 5 |
| Resin 1 (650) | — | 20 | — | — |
| Resin 2 (-) | — | — | 20 | — |
| Resin 3 (13000) | — | — | — | 20 |
| Stearic acid | 2 | 2 | 2 | 2 |
| Anti-aging agent | 2 | 2 | 2 | 2 |
| Zinc oxide | 2 | 2 | 2 | 2 |
| Sulfur | 1.5 | 1.5 | 1.5 | 1.5 |
| Vulcanization accelerator | 2 | 2 | 2 | 2 |
| Evaluation | | | | |
| Index of wet grip performance | 100 | 100 | 95 | 108 |
| Index of fuel efficiency | 100 | 85 | 72 | 95 |

From the results of Table 1, it is seen that the pneumatic tires of the disclosure with a tread composed of the rubber composition comprising specified amounts of the specified rubber component, silica and the specified resin are excellent in wet grip performance and fuel efficiency in a good balance.

What is claimed is:

1. A pneumatic tire with a tread composed of a rubber composition comprising:
a rubber component and based on 100 parts by mass of the rubber component,
at least 0.5 part by mass of silica,
5 to 50 parts by mass of a resin having a melt viscosity (150° C.) of 12000 to 15000 mPa·s;
wherein the rubber component comprises 40 to 100% by mass of a styrene-butadiene rubber and 0 to 60% by mass of a butadiene rubber;
wherein the resin is at least one selected from the group consisting of a terpene phenol resin, a phenol resin and an alkylphenol resin.

2. The pneumatic tire of claim 1, wherein the resin is a terpene phenol resin obtained by polymerizing phenol and at least a terpene selected from the group consisting of α-pinene, β-pinene, dipentene, and limonene, at a molar ratio of terpene to phenol in the range from about 1:1 to about 4:1.

3. The pneumatic tire of claim 1, wherein the resin is a terpene phenol resin obtained by adding to a phenol-boron trifluoride complex mixture at least a terpene selected from the group consisting of α-pinene, β-pinene, dipentene, and limonene, at a molar ratio of terpene to phenol in the range from about 1:1 to about 4:1, and wherein the boron trifluoride complex is selected from ether complexes of boron trifluoride and organic acid complexes of boron trifluoride.

4. The pneumatic tire of claim 1, wherein the resin is a terpene phenol resin having a softening point in the range of 110-135° C.

5. The pneumatic tire of claim 1, wherein the rubber composition further comprises 1 to 150 parts by mass of carbon black.

6. The pneumatic tire of claim 1, wherein the rubber composition further comprises at least a coupling agent selected from the group of: a sulfur-based coupling agent, an organic peroxide-based coupling agent, an inorganic coupling agent, a polyamine coupling agent, a resin coupling agent, a sulfur compound-based coupling agent, oxime-nitrosamine-based coupling agent, and sulfur.

7. The pneumatic tire of claim 1, wherein the rubber composition further comprises 1 to 20 parts by mass of a silane coupling agent based on 100 parts by mass of silica.

8. The pneumatic tire of claim 1, wherein the rubber is at least one selected from the group of natural rubber (NR), styrene-butadiene rubber (SBR), butadiene rubber (BR), synthetic polyisoprene rubber, epoxylated natural rubber, nitrile-hydrogenated butadiene rubber NHBR, hydrogenated styrene-butadiene rubber HSBR, ethylene propylene diene monomer rubber, ethylene propylene rubber, maleic acid-modified ethylene propylene rubber, butyl rubber, isobutylene-aromatic vinyl or diene monomer copolymers, brominated-NR, chlorinated-NR, brominated isobutylene p-methylstyrene copolymer, chloroprene rubber, epichlorohydrin homopolymers rubber, epichlorohydrin-ethylene oxide or allyl glycidyl ether copolymer rubbers, epichlorohydrin-ethylene oxide-allyl glycidyl ether terpolymer rubbers, chlorosulfonated polyethylene, chlorinated polyethylene, maleic acid-modified chlorinated polyethylene, methylvinyl silicone rubber, dimethyl silicone rubber, methylphenylvinyl silicone rubber, polysulfide rubber, vinylidene fluoride rubbers, tetrafluoroethylene-propylene rubbers, fluorinated silicone rubbers, fluorinated phosphagen rubbers, styrene elastomers, thermoplastic olefin elastomers, polyester elastomers, urethane elastomers, and polyamide elastomers

9. A pneumatic tire with a tread composed of a rubber composition comprising:
a rubber component and based on 100 parts by mass of the rubber component,
at least 0.5 part by mass of silica, and
5 to 50 parts by mass of a resin obtained by adding to a phenol-boron trifluoride complex mixture at least a terpene selected from the group consisting of α-pinene, β-pinene, dipentene, and limonene, at a molar ratio of terpene to phenol in the range from about 1:1 to about 4:1, and wherein the boron trifluoride complex is selected from ether complexes of boron trifluoride and organic acid complexes of boron trifluoride,
wherein the resin has a softening point between 80 and 140° C.

10. A method for constructing a pneumatic tire with improved wet grip performance and fuel efficiency, the method comprising:
selecting a resin having a melt viscosity (150° C.) of 12000 to 15000 mPa·s, the resin is at least one selected from the group consisting of a terpene phenol resin, a phenol resin and an alkylphenol resin;
preparing a rubber composition comprising: a rubber component and based on 100 parts by mass of the rubber component, at least 0.5 part by mass of silica, and 5 to 50 parts by mass of the resin having a melt viscosity (150° C.) of 12000 to 15000 mPa·s; and
forming the pneumatic tire from the rubber composition.

11. The method of claim 10, wherein the resin is a terpene phenol resin obtained by polymerizing phenol and at least a terpene selected from the group consisting of α-pinene, β-pinene, dipentene, and limonene, at a molar ratio of terpene to phenol in the range from about 1:1 to about 4:1.

12. The method of claim 10, wherein the resin is a terpene phenol resin obtained by adding to a phenol-boron trifluoride complex mixture at least a terpene selected from the group consisting of α-pinene, β-pinene, dipentene, and limonene, at a molar ratio of terpene to phenol in the range from about 1:1 to about 4:1, and wherein the boron trifluoride complex is selected from ether complexes of boron trifluoride and organic acid complexes of boron trifluoride.

13. The method of claim 10, wherein the resin is a terpene phenol resin having a softening point in the range of 110-135° C.
